(19) United States
(12) Patent Application Publication
(10) Pub. No.: US 2020/0347923 A1
(43) Pub. Date: Nov. 5, 2020

(54) CLINCH PULLEY STUD

(71) Applicant: PSM IP LIMITED, Youngstown, OH (US)

(72) Inventor: Robert MANGAPORA, Canfield, OH (US)

(21) Appl. No.: 16/503,904

(22) Filed: Jul. 5, 2019

Related U.S. Application Data
(60) Provisional application No. 62/841,475, filed on May 1, 2019.

(51) Int. Cl. F16H 57/00; F16H 55/36

(52) U.S. Cl. CPC F16H 57/0031; F16H 55/36

(57) ABSTRACT

A clinch pulley stud for mounting a pulley wheel to a plate is disclosed. The clinch pulley stud, the pulley wheel, and the plate may be assembled together using a cold forming process. The clinch pulley stud may have a relatively larger diameter head, a cylindrical shank which acts as the stub shaft for the pulley wheel, wherein an end of the cylindrical shank being remote from the head and being connected to a smaller diameter shank via a shoulder. The shoulder may be flat and/or include an annual groove into which the plate may be deformed. The clinch pulley stud may also include a threaded shaft extending beyond the smaller diameter shank. To resist rotation after the clinch pulley stud is cold formed to the plate, the clinch pulley stud includes one or more splines, ribs, studs, or flat facets on the shoulder or on the narrow shank against which the plate is cold formed.

### CROSS-REFERENCE TO RELATED APPLICATION

This application claims priority to and the benefit of U.S. Provisional Patent Application Ser. No. 62/841,475 filed May 1, 2019, which is incorporated by reference herein in its entirety.

### BACKGROUND

Pulley wheels are utilized in numerous applications. The pulley wheel is often attached to a metal sheet and, in these cases, a stub shaft or axle is attached to the sheet, for example, by spot welding. Then, the pulley wheel is fixed on the stub shaft or axle, and the pulley wheel is retained thereon via a spring clip engaging in a peripheral groove in the stub shaft, conventionally with the interposition of a washer or bush. In many cases, the metal sheet then has to be fixed in place via a secondary operation. Thus, the installation of a pulley wheel in a piece of equipment requires two separate operations, which is inefficient in terms of time and cost. It may therefore be desirable to produce a pulley wheel arrangement, where the fixture of the stub shaft for the wheel itself and the provision of fixing means for the assembly of stub shaft on a plate-like metal substrate are combined.

### SUMMARY

Disclosed herein is a clinch pulley stud. The clinch pulley stud may be utilized in a variety of applications and, in one example, the clinch pulley stud is utilized for mounting a pulley wheel to a plate or other workpiece. Thus, also disclosed herein is a pulley stud assembly comprising a pulley stud, a pulley wheel, and a workpiece such as a plate.

In some examples, the present disclosure relates to a pulley stud assembly. The pulley stud assembly may comprise a pulley stud extending along a longitudinal axis, a pulley wheel, and a metal plate. The pulley stud may have a head of an enlarged diameter relative to a cylindrical shank extending from the head, and the pulley wheel may be disposed about a pulley surface of the cylindrical shank, between the plate and the head of the pulley stud. The pulley stud further comprises a clinching section extending from a shoulder of the cylindrical shank along the longitudinal axis, away from the head, and extending into a threaded shaft, wherein the clinching section is configured to inhibit rotation of the pulley stud when fastened to the metal plate, and wherein the metal plate has an aperture and edges surrounding the aperture, the edges of the aperture are at least partly deformed around the clinching section of the pulley stud when the pulley stud is mounted thereto. Here, the clinching section may include at least one spline protruding from the shoulder, and the at least one spline may extend radially from the longitudinal axis and/or the at least one spline may be symmetrically arranged relative to the longitudinal axis. In these examples, the at least one spline may be a plurality of splines, which may be arranged in a variety of different patterns, including but not limited to, a propeller pattern, a S-curve pattern, a secant pattern, and a radial secant pattern, and combinations of the same.

The clinching section may include a spline surface extending from the shoulder along the longitudinal axis, and a plurality of splines may extend radially therefrom. The spline surface may be coaxial with the pulley surface, and at least one of the plurality of splines may extend radially a distance that is less than or equal to a radius defining the pulley surface. The spline surface is defined by a spline radius about the longitudinal axis and, in some examples, at least a portion of the at least one splines does not extend along the spline radius.

The pulley stud may include an insertion section extending from the clinching section towards the threaded shaft, and the insertion section may be configured to be received within the aperture of the metal plate when the clinching section of the pulley stud engages a front face the metal plate. In some of these examples, the insertion section includes a protrusion that engages a rear face of the metal plate when the insertion section is arranged within the aperture of the metal plate. And, in some of these examples, when the pulley stud is fastened to the metal plate, the front face of the metal plate deforms over the clinching section and the rear face of the metal plate deforms over the protrusion.

In other examples, the present disclosure relates to a clinch pulley stud. The clinch pulley stud may comprise a body extending along an axis, the body having a pulley portion and an at least partially threaded stud portion extending from the pulley portion along the axis. In these other examples, the pulley portion may include a first shank and a second shank, which together define a shoulder that interposes the first shank and the second shank. The first shank is configured to receive a pulley wheel, and the second shank extends from the shoulder and further includes a clinching section arranged proximate to the shoulder and an insertion section extending from the clinching section into the at least partially threaded stud portion. Here, the clinching section may be configured to engage a workpiece and inhibit rotation of the body relative to the workpiece when the workpiece is deformed over the clinching section.

The clinch pulley stud may further comprise at least one spline. The at least one spline may be arranged on the shoulder such that, when the clinch pulley stud is fastened to the workpiece, the at least one spline deforms a front face of the workpiece over the clinching section. Thus, the workpiece will deform over the at least one spline. In some examples, the at least one spline includes a plurality of splines arranged in a pattern selected from the group consisting of a propeller pattern, a S-curve pattern, a secant pattern, and a radial secant pattern, and combinations thereof. In some examples, the insertion portion is arrangeable within an aperture of the workpiece and includes a protrusion that engages a rear face of the workpiece when the front face of the workpiece deforms over the at least one spline; and, in these examples, the protrusion may be configured to deform the rear face of the workpiece.

According to yet another aspect of the present disclosure, there is provided a stud having a cylindrical shank of a first diameter connected to a shank portion of a second, smaller diameter via a shoulder having an annular groove, the shank portion mounting a shaft provided with a fixing configuration; characterized in that the shank is adapted to act as a stub shaft for a pulley and is provided with a head of enlarged diameter relative to the shank to retain the pulley; the end of the shank remote from the head being connected to the smaller shank portion; the annular groove extending from the plane of the shoulder towards the head; and the shaft extending away from the head. Such a stub may be used to mount a pulley wheel to a metal plate by (i) providing in the metal plate a hole of diameter equal to or slightly exceeding that of the smaller shank portion; (ii) placing the pulley wheel over the first diameter shank portion, the axial dimension of the pulley wheel being at most equal to the axial extent of the first diameter shank portion; (iii) inserting the smaller shank portion through the hole in the metal plate; and (iv) cold forming the metal plate into the smaller diameter shank portion to deform the metal plate such that un-deformed stud is secured within a deformed portion of the metal plate. This leaves a stud attached to the metal plate with the pulley wheel mounted to one side of the plate and the shaft extending on the other side. The shaft may be fixed in place where desired simply by inserting it through a suitable hole in the structure of the machine or the like and attaching a mating fixture, for example a nut, optionally with a locking washer, if the nut is not itself self-locking, onto the shaft if it is threaded.

According to yet another aspect of the present disclosure, there is provided an assembly comprising a stud, a pulley wheel, and a metal plate, wherein the pulley stud has a head of large diameter relative to a shank extending from the head, the shank being cylindrical and having a first portion constituting a stub shaft for the pulley wheel, and wherein the end of the shank first portion remote from the head is connected to a smaller diameter shank portion via a shoulder, and wherein located on the side of the smaller diameter shank portion and extending away from the head is a shaft having a fixing configuration, there being on one of the shoulder or the smaller diameter shank portion a torsional resistance-enhancing configuration, and wherein the metal plate has an aperture, the edges of which and the face of the metal plate surrounding the aperture are at least partly deformed into contact with the torsional resistance-enhancing configuration, and the pulley wheel being held captive between the plate and the head of the stud. The exterior surface of the smaller diameter shank portion and/or the interior of the annular groove and/or of the shoulder if without a groove is/are provided with a torsional resistance-enhancing configuration; this may be, for example, axial ribs or radial ribs or studs or flat facets into which the metal of the plate is formed for retention. Such formations render the stub shaft resistant to rotation about its axis once it is mounted to the plate, by providing a secure physical interlocking between the formations and the parts of the plate deformed against them. If the axial dimension of the pulley wheel is less than that of the larger diameter portion of the shank, one or more spacers or washers may be provided as appropriate to prevent the pulley moving axially on the shank after the stud has been installed in the metal plate.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is isometric view of an exemplary clinch pulley stud that may incorporate the principles of the present disclosure.

FIG. 2 is a side view of the clinch pulley stud of FIG. 1.

FIG. 3 illustrates a detailed view of FIG. 2.

FIG. 4 illustrates an end view of the clinch pulley stud of FIGS. 1-2 having an exemplary torque resistance locking feature.

FIG. 5 is an end view of the clinch pulley stud of FIGS. 1-2 having an alternate exemplary torque resistance locking feature.

FIG. 6 is an end view of the clinch pulley stud of FIGS. 1-2 having another exemplary torque resistance locking feature.

FIG. 7 is an end view of the clinch pulley stud of FIGS. 1-2 having another exemplary torque resistance locking feature.

FIG. 8 is an end view of the clinch pulley stud of FIGS. 1-2 having another exemplary torque resistance locking feature.

FIG. 9 is an end view of the clinch pulley stud of FIGS. 1-2 having another exemplary torque resistance locking feature.

FIG. 10 is an end view of the clinch pulley stud of FIGS. 1-2 having another exemplary torque resistance locking feature.

FIG. 11A-11B are top and bottom exploded views of a stud, pulley and plate assembly that may incorporate the principles of the present disclosure.

FIG. 12 is a cross section of the stud, pulley and plate assembly of FIG. 1 in assembled form depicting example operation.

### DETAILED DESCRIPTION

The present disclosure is related to fixing pulley wheels to plate-like structures and, more particularly, to assemblies that can be used to fix pulley wheels to plate-like structures.

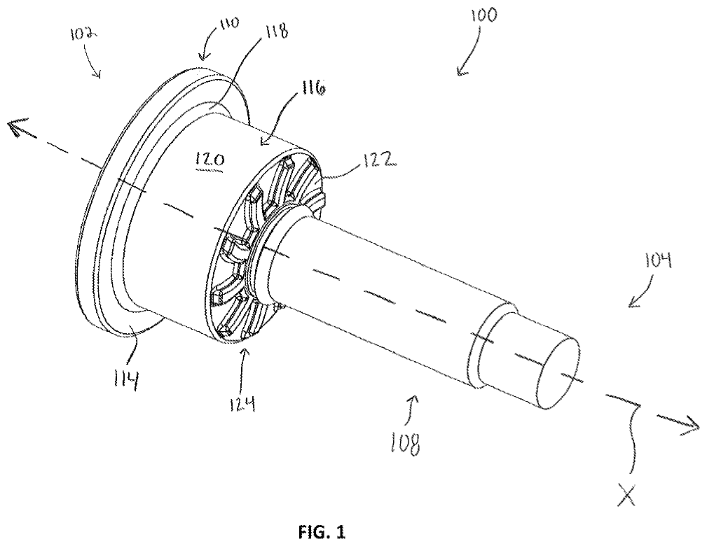

FIGS. 1-4 illustrate an exemplary clinch pulley stud 100, according to one or more embodiments of the present disclosure. The depicted clinch pulley stud 100 is just one example clinch pulley stud that can suitably incorporate the principles of the present disclosure. Indeed, many alternative designs and configurations of the clinch pulley stud 100 may be employed, without departing from the scope of this disclosure.

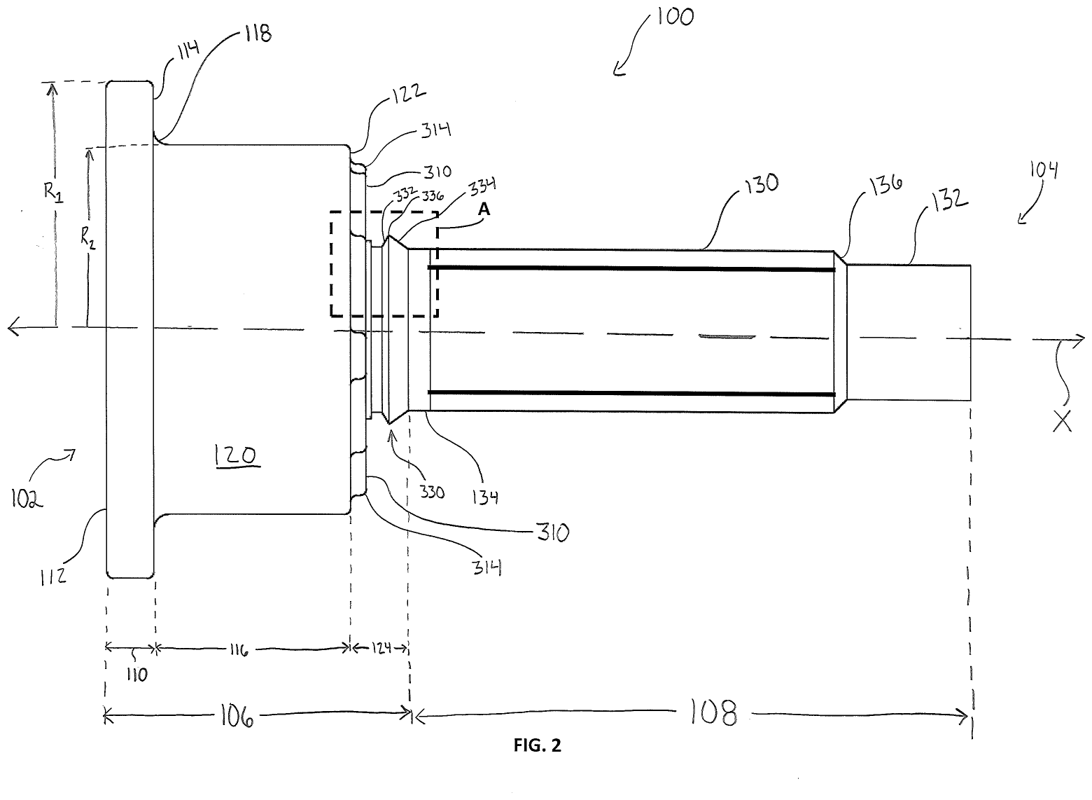

As illustrated in FIG. 1, the clinch pulley stud 100 includes a body and extends along a longitudinal axis X, from a first end 102 of the body to a second end 104 of the body. The clinch pulley stud 100 includes different segments or sections evaluated along the longitudinal axis X, as illustrated in FIG. 2. FIG. 2 is a side view of the clinch pulley stud 100 of FIG. 1. In the illustrated example, the clinch pulley stud 100 includes a pulley portion 106 arranged proximate to the first end 102 and an at least partially threaded stud portion 108 (hereinafter referred to as the “stud portion 108”) arranged proximate to the second end 104. The pulley portion 106 extends along the longitudinal axis X from the first end 102 to the stud portion 108, and the stud portion 108 extends along the longitudinal axis X from the pulley portion 106 to the second end 104.

The pulley portion 106 includes a head 110 arranged at the first end 102 and radially extending from the longitudinal axis X a flange radius R₁ to define a flange having an outer face 112 and an inner face 114. The pulley portion 106 also includes a first shank 116 extending from the inner face 114 of the head 110 along longitudinal axis X towards the second end 104. In the illustrated example, the first shank 116 includes a radius 118 at an end of the first shank 116 at which it is joined to the inner face 114 of the head 110. The radius 118 may have various dimensions depending on the particular application and, in some examples, the radius 118 is replaced with a taper joining the first shank 116 to the inner face 114, or no radius 118 (or taper) is provided at all.

The first shank 116 radially extends from the longitudinal axis X a distance equal to a first shank radius R₂ that, in the illustrated example, is less than the flange radius R₁ of the head 110. The first shank 116 is configured as a stub shaft for a pulley wheel, and thus includes a pulley surface 120 that is configured to receive a pulley wheel, which may have various contours, curvatures, and/or geometries depending on the particular end-use application and/or the pulley wheel to be installed thereon. The pulley surface 120 is radially off-set from the longitudinal axis X by a distance equal to the first shank radius R₂ and extends along the longitudinal axis X from the inner face 114 of the head 110 (or, where provided, the radius 118) to a shoulder 122 of the first shank 116. In the illustrated example, the pulley surface 120 defines a cylindrical shape having a substantially uniform diameter.

The shoulder 122 may have various contours, curvatures, or geometries depending on the particular end-use application. In some examples, the shoulder 122 defines a surface that is substantially flat and oriented perpendicular to the longitudinal axis X and, in some of these examples, the substantially flat surface defined by the shoulder 122 is also normal to the pulley surface 120. In some examples, the shoulder 122 includes a curved surface that curves or bows inward towards the first shank 116 (and towards the first end 102) to define an annular shaped recess (or concave surface) therein; whereas, in other examples, the shoulder 122 includes a curved surface that curves or bows outward away from the first shank 116 (and towards the second end 104) to define a ridge or a convex surface thereon.

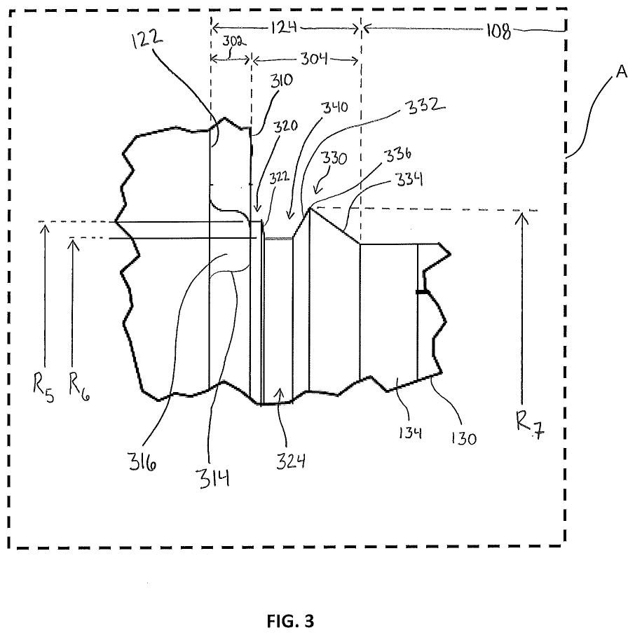

The pulley portion 106 also includes a second shank 124 extending along the longitudinal axis X from the shoulder 122 of the first shank 116 towards the second end 104. FIG. 2 includes a detail A drawn around a portion of the second shank 124. In particular, detail A of FIG. 2 highlights an exemplary geometry of the second shank 124 interconnecting the first shank 116 to the stud portion 108 of the clinch pulley stud 100. FIG. 3 is a close-up view of this exemplary geometry of the second shank 124 highlighted within detail A of FIG. 2. As further described below, the second shank 124, or at least a portion thereof, is configured to cause or create deformation of a work piece (e.g., a sheet of metal) when the clinch pulley stud 100 is fastened thereto. Thus, the clinch pulley stud 100 is configured to deform a work piece.

The stud portion 108 includes a plurality of threads and, as illustrated in the example embodiments, may also include one or more non-threaded portions proximate to the second end 104 and/or at the opposite end of the stud portion 108. In the illustrated example, the stud portion 108 includes a threaded shaft 130 having a plurality of threads, and the stud portion 108 also includes a pair of non-threaded shafts 132, 134 on either end of the threaded shaft 130. In addition, the stud portion 108 may have uniform diameter, or may have one or more coaxial portions with greater or lesser diameters. In the illustrated example, the threaded shaft 130 and the non-threaded shaft 134 are coaxial and have the same diameter; whereas, the non-threaded shaft 132 is coaxial with a smaller diameter. Also, the non-threaded shaft 132 is separated from the remainder of the stud portion 108 via a shoulder 136. Here, the shoulder 136 is flat and angled, but may have different geometries and or orientations.

As illustrated in FIG. 3, the second shank 124 includes a clinching section 302. The clinching section 302 is arranged proximate to the shoulder 122 and extends axially therefrom along the longitudinal axis X towards the second end 104. As further described below, the clinching section 302 is configured to inhibit rotation of the clinch pulley stud 100 when fastened to a work piece and, therefore, a portion of the clinching section 302 may be configured to deform the work piece as the clinch pulley stud 100 is fastened thereto. The second shank portion 124 also includes an insertion section 304 that is to be located within a hole in the work piece during use of the clinch pulley stud 100, and in some examples a portion of the insertion portion 304 is also configured to deform the work piece as the clinch pulley stud 100 is fastened thereto as hereinafter described. Thus, the clinch pulley stud 100 may be secured within that deformed portion(s) of the work piece, with the work piece deforming over those portions of the clinch pulley stud 100, such that relative movement between the clinch pulley stud 100 and the work piece is inhibited. The insertion section 304 is arranged proximate to the clinching section 302 and extends axially therefrom along the longitudinal axis X towards the second end 104, terminating at the stud portion 108. Thus, as generally illustrated in FIG. 2, the clinching section 302 extends between first shank 116 and the insertion section 304, and the insertion section 304 extends between the clinching section 302 and the stud portion 108.

The clinching section 302 extends along the longitudinal axis X towards a clinching face 310 thereof that is oriented generally normal to the longitudinal axis X. As shown in FIG. 4, which is an end view of the clinch pulley stud 100 from the second end 104, the clinching section 302 also defines a spline surface 312 that is radially offset from the longitudinal axis X a second shank radius R₃ that is less than the first shank radius R₂ defined by the first shank 116. In the illustrated example, the spline surface 312 defines a generally cylindrical shape that extends along the longitudinal axis X and is coaxial with the pulley surface 120. However, the spline surface 312 have different geometries in other examples.

The clinching section 302 further includes one or more locking features configured to resist torsion (i.e., backing-off) of the clinch pulley stud 100 when fastened to a work piece as described below. The locking features may be differently configured. In some examples, the locking features are one (1) or more splines 314 that extend outward from the spline surface 312 to their tips 316, which project a circle defined by a spline radius R₄ when rotated about the longitudinal axis X. As described below, the one or more splines 314 may be oriented along a radius line or along a secant line, or both, and may be straight, curved, and/or angled. The spline radius R₄ is thus larger than the second shank radius R₃ of the clinching section 302, and may be equal to or less than the first shank radius R₂ of the first shank 116. Where the clinch pulley stud 100 includes more than one (1) spline 314, the splines 314 may each define equal or different spline radii R₄. Also, the splines 314 integrally extend from the shoulder 122 axially along the longitudinal axis X towards the second end 104. In some examples, the clinching section 302 includes just one (1) spline; however, the clinching section 302 may have any number of splines without departing from the present disclosure. In addition, the splines 314 may have various geometries and, in embodiments having more than one (1) spline 314, the splines 314 may all have the same geometry or may have any number of different geometries or combinations of one (1) or more different geometries. Regardless of number and geometry, the splines 314 are configured to lock into the work piece to prevent rotation of the clinch pulley stud 100 when fastened thereto. Example splines and anti-rotation features, along with example deformation configurations, are described in U.S. Pat. No. 6,607,339, the content of which is hereby incorporated by reference.

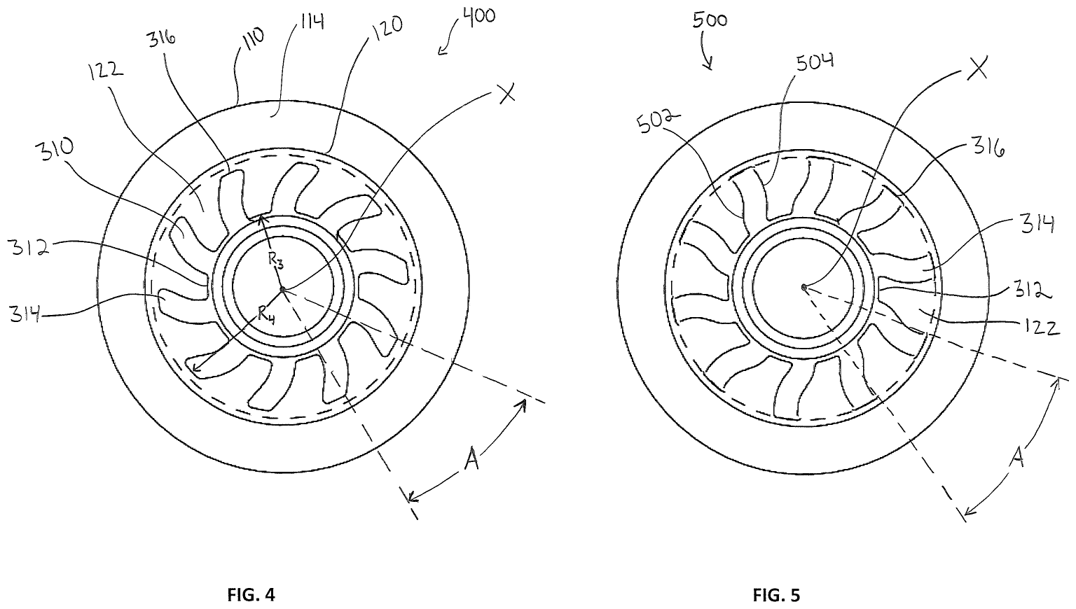

FIG. 4 illustrates an exemplary arrangement of the splines 314, according to one or more embodiments of the present disclosure. In the illustrated example, the clinching section 302 includes ten (10) splines 314. Here, the splines 314 are configured as curved rib members extending radially from the spline surface 312 and bending or curving as they extend towards their tips 316. As exemplified in FIG. 4, the splines 314 may be provided in a “propeller” arrangement where they each curve in a clockwise direction, but may instead curve in a counter-clockwise direction. Here, the clinching face 310 extends over face portions of the splines 314 that are oriented generally normal to the longitudinal axis X; however, the face portions of the splines 314 may be off-set towards the first end 102 or second end 104 relative to the longitudinal axis X. Forming the splines 314 in a “propeller” arrangement such as that illustrated in FIG. 4 has been shown to increase torque retention performance of the clinch pulley stud 100 by approximately 15% to 20% based upon the material type and thickness of the work piece that the clinch pulley stud 100 is pressed into. Also, the splines 314 radially extend outward from the longitudinal axis X such that their tips 316 each define a spline radii R₄ that is less than the first shank radius R₂ of the first shank 116; however, in other examples, at least one of the spline radii R₄ is equal to the first shank radius R₂. In other examples, one or more of the splines 314 may be straight ribs oriented radially outward from the longitudinal axis X along a radius; or may be ribs comprised of separate (straight or curved) segments arranged one after another and oriented at an angle relative to each other; etc. The splines 314, however, may be differently arranged as described below with reference to FIGS. 5-10.

As best illustrated in FIG. 3, the insertion section 304 of the second shank portion 124 includes a first insertion shaft 320 axially extending from the clinching face 310 along the longitudinal axis X towards the second end 104 of the clinch pulley stud 100. Here, the first insertion shaft 320 is generally cylindrical and is defined by a fourth shank radius R₅ that, in the illustrated example, is less than the second shank radius R₃ that defines the spline surface 312. In addition, the first insertion shaft 320 includes a shoulder 322 that defines a surface radially extending from the longitudinal axis X at an angle. The shoulder 322 may be oriented at any number of (positive or negative) angles relative to the longitudinal axis X without departing from the present disclosure and, in some examples, the shoulder 322 is approximately normal to the longitudinal axis X.

The insertion section 304 of the second shank portion 124 also includes a second insertion shaft 324 axially extending from the shoulder 322 of the first insertion shaft 320 along the longitudinal axis X towards the second end 104 of the clinch pulley stud 100. Here, the second insertion shaft 324 is generally cylindrical and is defined by a fifth shank radius R₆ that, in the illustrated example, is less than the fourth shank radius R₅ that defines the first insertion shaft 320.

In addition, the insertion section 304 of the second shank portion 124 also includes a protruding feature 330. The protruding feature 330 may have various geometries without departing from the present disclosure. Here, the protruding feature 330 is formed from two generally flat surfaces 332, 334 that each radially extend from the longitudinal axis X at non-right-angles such that the two generally flat surfaces 332, 334 meet at a point 336. As illustrated, the point 336 is located a distance from the longitudinal axis X equal to a point radius R7 that is greater than the fifth shank radius R₆.

Moreover, the insertion section 304 of the second shank portion 124 also includes an annular recess 340. As illustrated, the annular recess 340 is formed by the geometry of the first insertion shaft 320, the second insertion shaft 324, and the protruding feature 330. Thus, the geometry of the annular recess 340 depends on the particular arrangement of the first insertion shaft 320, the second insertion shaft 324, and the protruding feature 330. The annular recess 340 may have various geometries without departing from the present disclosure and, therefore, the annular recess 340 may be differently configured from that illustrated in the figures. For example, the annular recess 340 may instead include one or more curved surfaces that correspond with one or more similarly curved surfaces of the first insertion shaft 320, the second insertion shaft 324, and the protruding feature 330.

As mentioned above, the clinch pulley stud 100 includes one or more locking features configured to resist torsion when it is fastened to a work piece. For example, FIGS. 1-4 illustrate the clinch pulley stud 100 having a plurality of splines 314 arranged in a propeller pattern 400, according to one or more embodiments of the present disclosure. More particularly, the splines 314 are “C-shaped” and each extend from the spline surface 312 with a slight curvature and, as they extend towards an outer periphery of the clinch pulley stud 100, they all curve a clockwise direction as illustrated in FIG. 4. The splines 314 are each joined to the spline surface 312 at locations aligned upon a radius thereof that extends through the longitudinal axis X. Thus, while the splines of FIG. 4 all radially extend from the spline surface 312, they include curvatures causing them to deviate from a radius, which thereby provides the propeller-like appearance of the propeller pattern 400. In other examples, one or more of the splines 314 may have larger or smaller clockwise curvatures, or may include one or more counter-clockwise curvatures, or any combination of the same. In addition, in other examples, the splines 314 need not extend from the spline surface 312 at points thereon aligned with a radius extending through the longitudinal axis X, but may be offset such that they extend from the spline surface 312 along a secant. Also, the splines 314 are evenly distributed such that an angle A between neighboring splines 314 is equal. In the illustrated example, the angle A at which each of the ten (10) splines 314 is oriented relative to its neighboring splines 314 is thirty-six degrees (36°); however, the splines 314 need not be evenly distributed and one or more of the splines 314 may extend at different angles A relative to its neighboring splines 314.

FIG. 5 illustrates an alternate example arrangement or pattern of the splines 314, according to one or more alternate embodiments of the present disclosure. In this example, the splines 314 are arranged in a double curve or “S-curve” pattern 500. Here, each of the splines 314 includes a pair of opposite curvatures 502, 504. More particularly, each of the splines 314 extends radially from the spline surface 312 and bend or curve in a clockwise direction at the first curvature 502, and then bend or curve in a counter-clockwise direction at the second curvature 504. The first curvature 502 and the second curvature 504 may have equal absolute amount of curvature, or they have different absolute amounts of curvature. In other examples, however, the “S-curve” of at least one of the splines 314 is reversed such that the curve counter-clockwise and then clockwise. In some examples, one or more of the splines includes at least one additional curvature that may be oriented similar to or different from its corresponding preceding curvatures 502, 504. Also, in the illustrated example, the “S-curve” pattern 500 includes ten (10) splines 314; however, the “S-curve” pattern 500 may include more or less splines 314 in other examples. Here, the splines 314 are evenly distributed such that the angle A at which each of the ten (10) splines 314 is oriented relative to its neighboring splines 314 is thirty-six degrees (36°); however, the splines 314 need not be evenly distributed and one or more of the splines 314 may extend at different angles A relative to its neighboring splines 314.

FIG. 6 illustrates another alternate example arrangement of the splines 314, according to one or more other alternate embodiments. In this example, the splines 314 are arranged in a secant pattern 600, where each of the splines 314 is oriented along a secant S. Thus, each of the splines 314 secantly extends from the spline surface 312 and, as illustrated in FIG. 6, the splines 314 secantly extend on a clockwise pattern. In other examples, however, one or more of the splines 314 secantly extend in a counter-clockwise pattern. Regardless of whether the splines 314 are arranged in a clockwise or counter-clockwise pattern, they may each be oriented at the same or different angles defined between the secant S and a tangent T to the spline surface 312 drawn next to the respective spline 314. Also, in the illustrated example, the secant pattern 600 includes ten (10) splines 314; however, the secant pattern 600 may include more or less splines 314 in other examples. Here, the splines 314 are evenly distributed such that an angle B at which each of the ten (10) secantly extending splines 314 is oriented relative to its neighboring secantly extending splines 314 is thirty-six degrees (36°); however, the secantly extending splines 314 need not be evenly distributed and one or more of the secantly extending splines 314 may extend at different angles B relative to the secants on which its neighboring splines 314 extend.

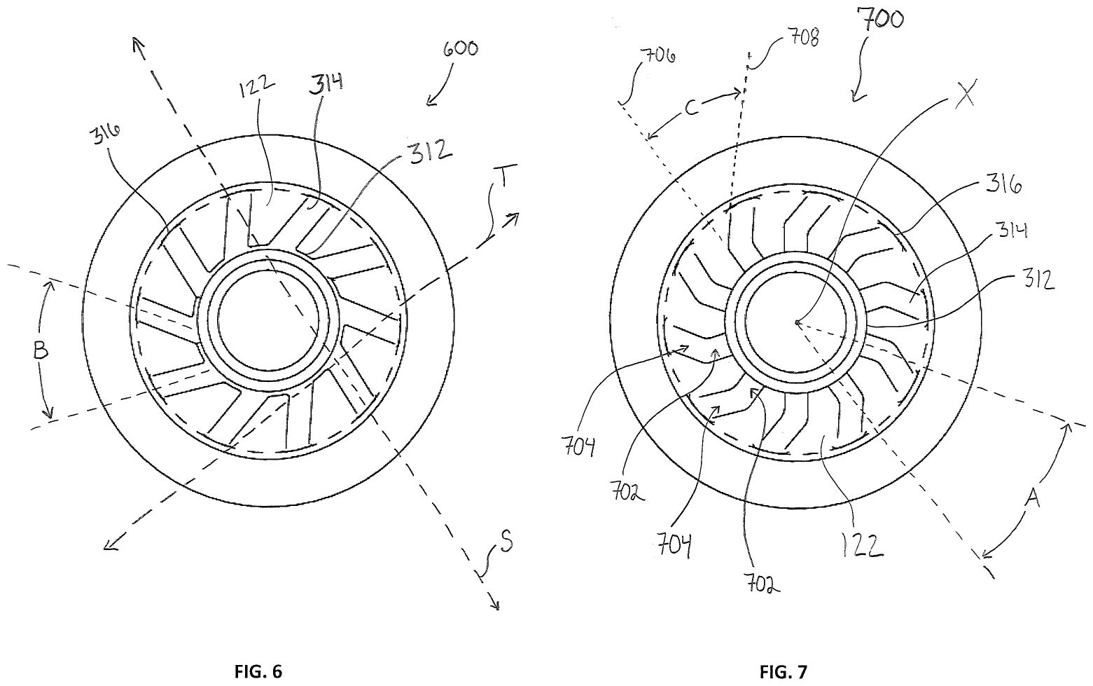

FIG. 7 illustrates another alternate example arrangement of the splines 314, according to one or more alternate embodiments of the present disclosure. In this example, the splines 314 are arranged in a radial secant pattern 700, with each of the splines 314 including a first spline segment 702 (i.e., a radial segment) and a second spline segment 704 (i.e., a secant segment) extending therefrom. Here, each of the first spline segments 702 radially extends from the spline surface 312 along a radius, as illustrated by the radius projection line 706, and each of the second spline segments 704 secantly extends from an end of its associated first spline segment 702 along a secant, as illustrated by the secant projection line 708. As illustrated, each of the second spline segments 704 is angled relative to the corresponding first spline segment 702. Thus, each of the second spline segments 704 extends from the corresponding first spline segment 702 at an angle C, which is defined between the radius projection line 706 and the secant projection line 708. The angle C may have any number of values. In the illustrated example, the angle C of each of the splines 314 is forty degrees (40°); however, one or more of the angles C may be a different acute angle, or one or more of the angles C may be a right angle or an obtuse angle. Also in the illustrated example, the angle C of each of the splines 314 is equal. In other examples, however, two or more of the splines 314 may include one or more different angles. Moreover, in the illustrated example, the angle C of each spline is positive, such that the second spline segments 704 are angled in a clockwise direction, as shown in FIG. 7. However, one or more of the second spline segments 704 may be oriented at a negative angle such that they point in a counter-clockwise direction. As illustrated, the first spline segments 702 of each spline 314 extends at the angle A relative to the first spline segments 702 of its neighboring splines 314. In the illustrated example, the ten (10) splines 314 are evenly distributed about the longitudinal axis X, such that the angle A between each neighboring pair of first spline segments 702 is thirty-six degrees (36°). However, the splines 314 need not be evenly distributed.

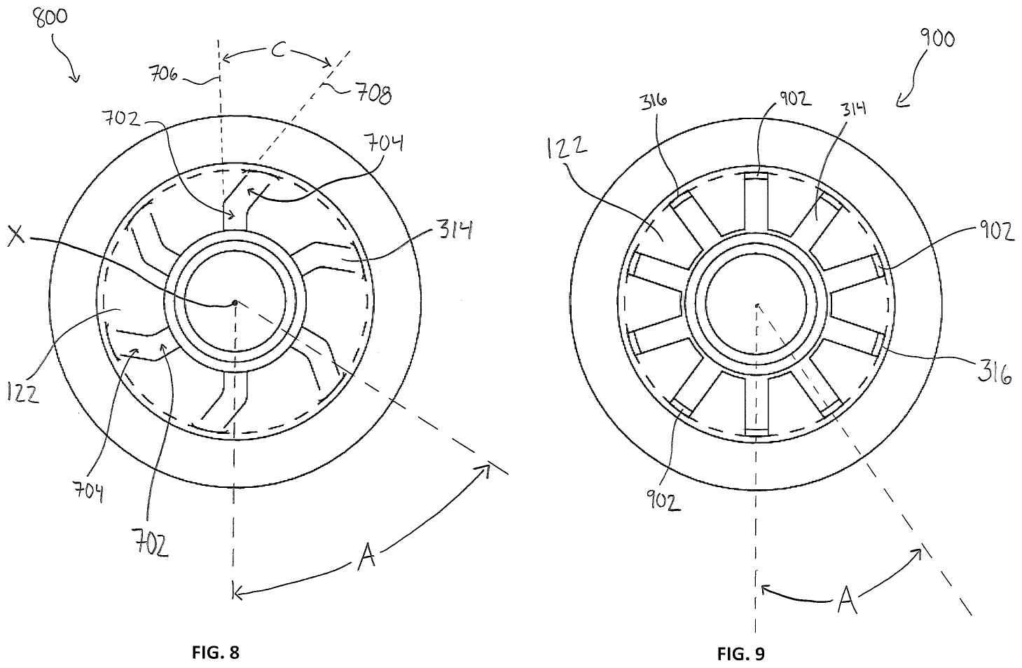

The exemplary radial secant pattern 700 illustrated in FIG. 7 includes ten (10) splines 314; however, the radial secant pattern 700 may include more or less splines 314 in other examples. FIG. 8 illustrates an alternate radial secant pattern 800, according to one or more alternate embodiments of the present disclosure. Here, the splines 314 are similarly configured as described with reference to FIG. 7, and thus include the first spline segment 702 (i.e., the radial segment) and the second spline segment 704 (i.e., a secant segment) extending therefrom at the angle C relative to the first spline segment 702. However, the radial secant pattern 800 of FIG. 8 includes six (6) splines 314 instead of the ten (10) splines 314 illustrated in FIG. 7. Nevertheless, different radial secant patterns may be provided with more or less than the ten (10) and six (6) splines 314 described with reference to FIGS. 7-8, without departing from the present disclosure. In the exemplary radial secant pattern 800, the six (6) splines 314 are evenly distributed about the longitudinal axis X, such that the angle A between neighboring first spline segments 702 is uniform or equal. Thus, each of the first spline segments 702 is oriented at sixty degrees (60°) relative its neighboring first spline segments 702. However, the splines 314 need not be evenly distributed.

FIG. 9 illustrates another alternate example arrangement of the splines 314, according to one or more alternate embodiments of the present disclosure. In the illustrated example, the splines 314 are arranged in a radial pattern 900 where each of the splines 314 extends along a radius. Here, the radially extending splines 314 are evenly distributed about the longitudinal axis X, such that the angle A at which each of the splines 314 is oriented relative to its neighboring splines 314 is thirty-six degrees (36°). In other examples, however, one or more of the splines 314 may be unevenly distributed relative to the others. Also in the illustrated example, each of the splines 314 includes a chamfer 902 formed into the tips 316 thereof. Here, the chamfer is an angled surface and each of the splines 314 include the same chamfer 902; however, one or more of the splines 902 may include differently configured chamfers. Also, one or more of the splines 314 may include at its respective tip 316 a radiused edge or another feature, without departing from the present disclosure.

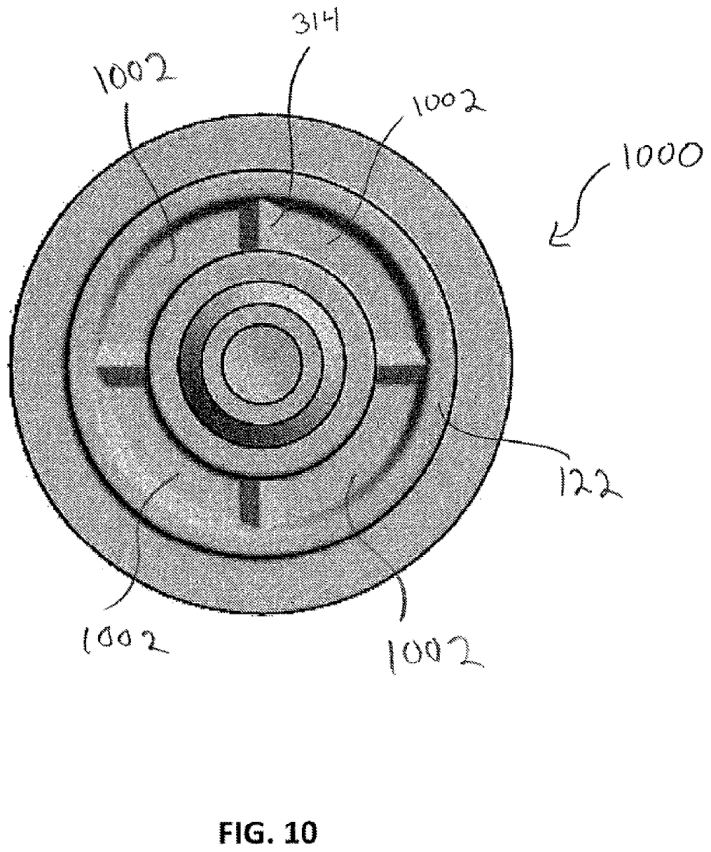

FIG. 10 illustrates another alternate example arrangement of the splines 314, according to one or more alternate embodiments of the present disclosure. In the illustrated example, the splines 314 are arranged in a recessed radial pattern 1000 where each of the splines 314 extends along a radius from the longitudinal axis X, outward (towards the second end 104) from a recessed surface 1002 formed into the shoulder 122. As illustrated, a recess 1004 is formed into the shoulder 122 towards the first end 102, to thereby expose the recessed surface 1002 which faces the second end 104. Here, there are four (4) splines 312 which segment the recessed surface 1002 into four (4) quadrants or portions, however, more or less than four (4) splines 314 may be utilized. Also, each of the splines 314 is oriented perpendicular to its neighboring splines 314, but they may be differently oriented. Also, recessed surface 1002 is illustrated as being flat and positioned normal to the longitudinal axis X; however, it may be contoured and include one or more curved or angled portions. Here, each quadrant of the recessed surface 1002 is uniform with each other, but one or more of the quadrants of the recessed surface 1002 may be differently oriented and/or positioned along the longitudinal axis X relative to the others.

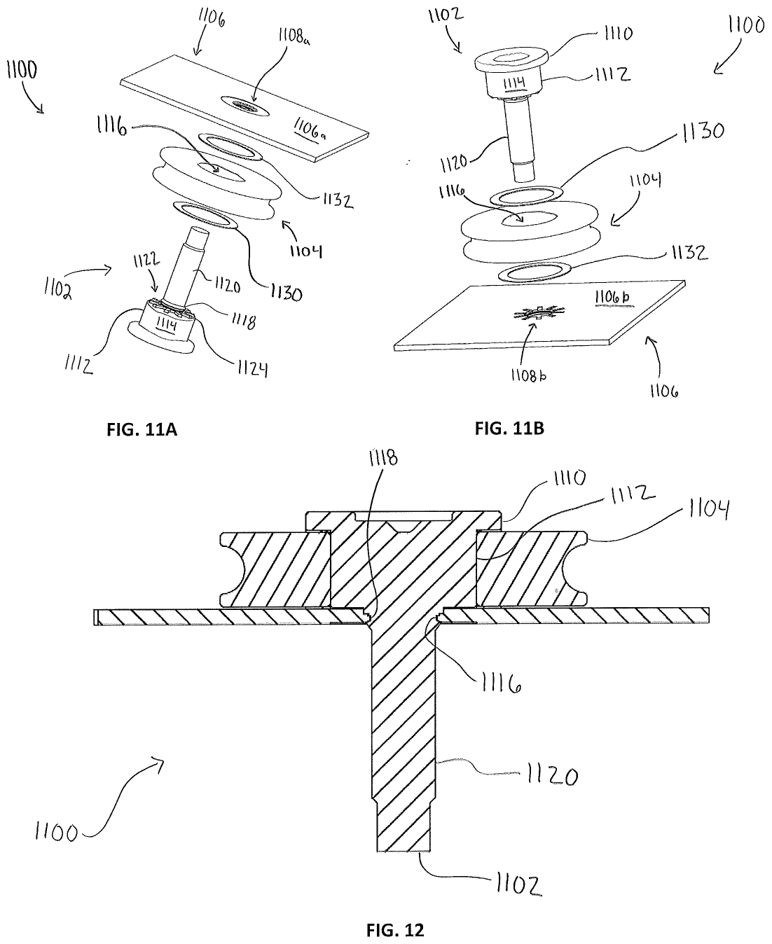

Referring first to FIGS. 11A, 11B, and 12, a clinch pulley stud assembly 1100 is illustrated before and after assembly. The clinch pulley stud assembly 1100 includes a clinch pulley stud 1102, a pulley wheel 1104, and a plate 1106. As previously described, the clinch pulley stud 1102 is utilized to couple the pulley wheel 1104 to the plate 1106. The clinch pulley stud assembly 1100 may also include one or more washers. FIGS. 11A and 11B are exploded upper and lower views, respectively, of the clinch pulley stud assembly 1100 when unassembled; whereas, FIG. 12 illustrates the clinch pulley stud assembly 1100 when assembled.

The plate 1106 includes an outer surface 1106a (FIG. 11A) and an inner surface 1106b (FIG. 11B) and an aperture or hole 1108a extending there through. In some examples, the plate 1106 is a component of a vehicle window lifting assembly; however, the plate 1106 may be part of various different assemblies, without departing from the present disclosure. The clinch pulley stud 1102 couples the pulley wheel 1104 to the inner surface 1106b of the plate 1106, and the inner surface 1106b of the plate 1106 deforms into and around the clinch pulley stud 1102, thereby inhibiting relative movement (i.e., rotation) of the clinch pulley stud 1102 relative to the plate 1106. As illustrated in FIG. 11B, installation of the clinch pulley stud 1102 on to the plate 1106 forms a deformation 1108b in the inner surface 1106b about the hole 1108a.

The clinch pulley stud 1102 may be configured as described herein. Thus, the clinch pulley stud 1102 may include a head portion 1110 with an outer face configured to be engaged with a tool driver and an inner face that, when assembled on the plate 1106, engages the outer face 1106a of the plate 1106. The clinch pulley stud 1102 also includes a shank portion 1112 having a pulley surface 1114 configured to fit within an inner aperture 1116 in the center of the pulley wheel 1104, an insertion portion 1118 configured to be received within the hole 1108a in the plate 1106, and a threaded shaft 1120 configured to receive a nut or other locking member to thereby secure the clinch pulley stud assembly 1100. In the illustrated example, the insertion portion 1118 extends from a clinching face 1122 of the shank portion 1112 that is located at an end of shank portion 1112 (opposite from the head portion 1110). The insertion portion 1118 (or at least a upper portion thereof) is configured to be inserted within the hole 1108a in the plate 1106.

The clinch pulley stud 1102 includes a plurality of splines 1124 arranged on the clinching face 1122. The splines 1124 extend axially from the clinching face 1122, coaxially with the insertion portion 1118. Also, the splines 1124 are radially arranged such that they each extend radially outward towards the pulley surface 1114. While the splines 1124 may have various arrangements or patterns, as described above, in the illustrated example, there are six (6) evenly distributed (i.e., equi-angularly spaced relative to each other) splines 1124 that each include tapered ends that terminate before the pulley surface 1114, and which axially extend along the insertion portion 1118 an axial length that is less than an axial length of the insertion portion 1118. The splines 1124 may be differently configured with the same or different dimensions, however. After the clinch pulley stud 1102 is inserted through the hole 1108a, it is tightened onto the plate 1106 (e.g., with a nut). Tightening the clinch pulley stud 1102 pulls the insertion portion 1118 into the hole 1108a and brings the splines 1124 and the clinching face 1122 into engagement with the inner surface 1106b of the plate 1106, thereby pressing the splines 1124 into the inner surface 1106b until the clinching face 1122 abuts the inner surface 1106b of the plate 1106. Regardless of their configuration, the splines 1124 deform the plate 1106 as they are pulled into engagement with the inner surface 1106b (e.g., via the locking nut) by forming the deformation 1108b in the plate 1106.

FIG. 12 illustrates a cross section of the clinch pulley stud assembly 1100 of FIGS. 11A and 11B when assembled. As illustrated, the deformation 1108b is formed by pressing a portion of the insertion portion 1122 proximate to the splines 1124, as well as the splines 1124 themselves, into the inner surface 1106b of the plate 1106. In this manner, the deformation 1108b mirrors the splines 1124 and the insertion portion 1122 of the shank from which they radially extend. After locking the clinch pulley stud 1102 onto the plate 1106, for example, with a lock nut, the clinch pulley stud 1102 is firmly fitted into the plate 1106, and cannot rotate as the splines 1124 lock into the deformed metal of the plate 1106. The fastening method may be differently performed, for example, as described in U.S. Pat. Nos. 3,938,239 and 4,018,257, and can be carried out using appropriate press tools in known in the art. More than one (1) clinch pulley stud 1102 and pulley wheel 1104 may be fitted to the same plate 1106 if appropriate.

As mentioned, the clinch pulley stud assembly 1100 may also include one or more spacing washers. In the illustrated example, a pair of the washers 1130, 1132 are positioned on either side of the pulley wheel 1104, with a first washer 1130 positioned between the head portion 1110 and the bottom surface of the pulley wheel 1104, and a second washer 1132 positioned between the inner surface 1106b of the plate 1106 and a top surface of the pulley wheel 1104.

The assembly of sheet metal component and pulley(s) may easily be mounted in place, e.g. on suitably apertured flanges in a vehicle door shell, by passing the threaded shafts 1120 through the apertures in the door shell and securing the clinch pulley stud assembly 1100 in place by threading a locknut or nut and locking washer (not illustrated) on to the threaded shaft 1120 and tightening the nut to the desired torque.

Although the present disclosure has been described with particular reference to its use in the construction of window actuation assemblies in the automotive industry, it will be appreciated that there are numerous other areas of application of pulleys, in many of which the combined pulley fixing and component fixing approach identified above may be usefully employed.

While the embodiments of the present disclosure may be utilized in a wide array of applications, they are of particular value in connection with the construction of automobile window movement systems. In these automobile window movement systems, movement of the window (e.g., up or down in a driver or passenger door) is conventionally achieved by mounting the window in generally vertically extending tracks and providing, on the bottom of the window, some form of mechanical linkage which raises or lowers the window itself. The drive for that mechanical linkage is conventionally provided either by a rotatably mounted crank handle set on the inside of a door or it may be produced from an electric motor. In either case, the conventional drive transmission method used is that of an extending belt or wire which runs over a series of pulleys. Mounting the pulleys to the usually metal plate components of the mechanism can save substantial quantities of time in the overall assembly of the window and winder gear.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A pulley stud assembly comprising:
a pulley stud extending along a longitudinal axis, a pulley wheel, and a metal plate, the pulley stud having a head of an enlarged diameter relative to a cylindrical shank extending from the head, the pulley wheel disposed about a pulley surface of the cylindrical shank, between the plate and the head of the pulley stud, the pulley stud further comprising a clinching section extending from a shoulder of the cylindrical shank along the longitudinal axis, away from the head, and extending into a threaded shaft,
wherein the clinching section is configured to inhibit rotation of the pulley stud when fastened to the metal plate, and
wherein the metal plate has an aperture and edges surrounding the aperture, the edges of the aperture are at least partly deformed around the clinching section of the pulley stud when the pulley stud is mounted thereto.

2. The pulley stud assembly of claim 1, wherein the clinching section includes at least one spline protruding from the shoulder.

3. The pulley stud assembly of claim 2, wherein the at least one spline extend radially from the longitudinal axis.

4. The pulley stud assembly of claim 2, wherein the at least one spline are symmetrically arranged about the longitudinal axis.

5. The pulley stud assembly of claim 2, wherein the at least one spline includes a plurality of splines arranged in a propeller pattern.

6. The pulley stud assembly of claim 2, wherein the at least one spline includes a plurality of splines arranged in a S-curve pattern.

7. The pulley stud assembly of claim 2, wherein the at least one spline includes a plurality of splines arranged in a secant pattern.

8. The pulley stud assembly of claim 2, wherein the at least one spline includes a plurality of splines arranged in a radial secant pattern.

9. The pulley stud assembly of claim 2, wherein the clinching section includes a spline surface extending from the shoulder along the longitudinal axis, wherein the at least one spline extends radially therefrom.

10. The pulley stud assembly of claim 9, wherein the pulley surface and the spline surface are coaxial with each other.

11. The pulley stud assembly of claim 10, wherein the pulley surface is defined by a radius about the longitudinal axis, and at least one of the at least one splines extends radially a distance that is less than or equal to the radius.

12. The pulley stud assembly of claim 2, wherein the spline surface is defined by a radius about the longitudinal axis, and at least a portion of the at least one splines does not extend along the radius.

13. The pulley stud assembly of claim 1, wherein the pulley stud includes an insertion section extending from the clinching section towards the threaded shaft, the insertion section configured to be received within the aperture of the metal plate when the clinching section of the pulley stud engages a front face the metal plate.

14. The pulley stud assembly of claim 13, wherein the insertion section includes a protrusion that engages a rear face of the metal plate when the insertion section is arranged within the aperture of the metal plate.

15. The pulley stud assembly of claim 14, wherein, when the pulley stud is fastened to the metal plate, the front face of the metal plate deforms over the clinching section and the rear face of the metal plate deforms over the protrusion.

16. A clinch pulley stud, comprising:
a body extending along an axis, the body having a pulley portion and an at least partially threaded stud portion extending from the pulley portion along the axis, wherein the pulley portion includes:
a first shank configured to receive a pulley wheel; and
a second shank extending from a shoulder interposing the first shank and the second shank, the second shank having a clinching section proximate to the shoulder and an insertion section extending from the clinching section into the at least partially threaded stud portion,
wherein the clinching section is configured to engage a workpiece and inhibit rotation of the body relative to the workpiece when the workpiece is deformed over the clinching section.

17. The clinch pulley stud of claim 16, further comprising at least one spline arranged on the shoulder, wherein, when the clinch pulley stud is fastened to the workpiece, the at least one spline deforms a front face of the workpiece over the clinching section.

18. The clinch pulley stud of claim 17, the at least one spline includes a plurality of splines arranged in a pattern selected from the group consisting of a propeller pattern, a S-curve pattern, a secant pattern, and a radial secant pattern, and combinations thereof.

19. The clinch pulley stud of claim 17, wherein the insertion portion is arrangeable within an aperture of the workpiece and includes a protrusion that engages a rear face of the workpiece when the front face of the workpiece deforms over the at least one spline.

20. The clinch pulley stud of claim 19, wherein the protrusion is configured to deform the rear face of the workpiece.
